(19) United States
(12) Patent Application Publication
(10) Pub. No.: US 2003/0016903 A1
(43) Pub. Date: Jan. 23, 2003

(54) Low loss interconnection for microwave switch array

(76) Inventors: Elim Chan, Sunnyvale, CA (US); Jules D. Levine, Santa Clara, CA (US); Mahendra Jain, Milpitas, CA (US); Chris McKleroy, Los Altos, CA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/909,959

(22) Filed: Jul. 23, 2001

(51) Int. Cl. G02B 6/35

(52) U.S. Cl. 385/16

(57) ABSTRACT

Microwave switching method and apparatus useful in high frequency operations (˜40 GHz) includes structure and/or steps for providing a plurality of parallel upper switch cards, each having at least one input and a plurality of outputs; and a plurality of parallel lower switch cards, each having a plurality of inputs and at least one output. The plurality of lower switch cards is disposed perpendicular to the plurality of upper switch cards. A connector board is disposed between the edges of the plurality of upper and lower switch cards, the connector board having a two-dimensional planar array of electrical-coupling terminals for electrically coupling the plurality of upper switch cards outputs to the plurality of lower switch card inputs. Preferably, the electrical-coupling terminals comprise solder bumps disposed at either end of metallized via holes through the board, the solder bumps couple to wells disposed at the edges of the upper and lower switch cards.

### BACKGROUND OF THE INVENTION

1. Field of the Invention

The present invention relates to an apparatus and a method for implementing a switching array for telecommunications, and more particularly to structure and process for coupling together upper and lower switch cards in a microwave switching array.

2. Description of the Related Art

A basic optical-to-microwave-to-optical telecommunications system 100 is shown in FIG. 1. The system 100, which is described in U.S. patent application Ser. No. 09/727,171, filed on Nov. 29, 2000 and entitled “Crossconnect Switch With A Flat Frequency Response And A High Cutoff Frequency” and is incorporated herein by reference, comprises a network input 105, a demultiplexer 110, a photodetector 115, an N×N wideband switch 120, a laser and modulator 125, a multiplexer 130, and a network output 135. See also T0014 U.S. patent application Ser. No. ______, filed on Jul. 16, 2001 and entitled “Optical-Microwave-Optical Switching Array for Telecommunications”, incorporated herein by reference.

An optical signal is transformed into a microwave signal at the photodetector 115, is passed into the microwave switch 120, and re-transformed back into an optical signal using the laser and modulator 125. The regenerating, reshaping, and retiming functions (3R) and their modifications, which may be carried out in the photodetector 1 15, the switch 120, and the modulator 125, are illustrated in FIG. 2.

In addition to the regeneration, reshaping, and retiming functions, there may be provided feedforward error correction circuits (not shown), which reduce the bit error rate (BER) of the system, and leveling circuits (also not shown) which can be used to flatten the frequency response of the switch to the frequency of the transmitted signal being passed through the switch.

The system 100, as described in U.S. patent application Ser. No. 09/727,171, involves a design in which two N×N switch plates are connected with N² via connections between them, as illustrated in FIG. 3. The N input rows are addressed from the left. Row #18 is shown explicitly. At point S1, a 1×N switch is used to direct the input row signal to any one of the N output column locations. A particular one of these is column 27, which is shown as point P. At point P, there is a via connecting this point on the input square with a similar point on the overlapping output square. Point P is connected through point S2 to the output column #27 by a N×1 switch located at point S2.

As described in T0014, U.S. patent application Ser. No. 09/______, filed on Jul. 16, 2001 and entitled “Optical-Microwave-Optical Switching Array for Telecommunications”, and referring to FIGS. 4, 5A, and 5B, the switch unit comprises a multiplicity of switch cards of two types. A switch card in the upper block is oriented in the X direction and a switch card in the lower block is oriented in the Y direction. The assembly of switch cards 405 in the upper block is oriented at right angles to the switch cards 410 of the lower block. Each switch card has an array of 1×N switches. For the switch cards in the upper block, the switches fan out downwards, and for the switch cards in the lower block, the switches fan out upwards. All of the switch cards may be identical, except for their orientations: X, Y, upwards or downwards. Preferably, each card is approximately 2.5 inches×6.0 inches.

A signal entering a top input of one of the switch cards 405 in the upper stack passes through an embedded 1×N splitter switch into one of N output locations at the base of the switch card 405. A signal entering a top input of one of the switch cards 410 in the lower stack passes through an embedded N×1 combiner switch into the output locations at the base of the switch card. By virtue of this structural design, where each card 405 has a single input, and each card 410 has a single output, any signal passing from any one of the N outputs in the upper stack can be passed to any of the N inputs in the lower stack. This is called an N x N switch. The purpose of the N×1 switch in the lower stack is to collect the N switch signals into one, with a minimum of reflection loss, a minimum of insertion loss, and a maximum of isolation between switch inputs and outputs.

In each card, a portion 505 of the card surface may be allocated for digital controls, because the combination of analog switches and digital controls is helpful for proper operation of the switches. In FIGS. 5A and 5B, this control area 505 is schematically shown as a gray square. The purpose of the digital control is to activate a signal path from one of the inputs to one of the multiple outputs. The digital control can be complex if there are many switches in series. Examples of such control logic and circuitry include field-programmable-gate-arrays (FPGA), programmable-logic-devices (PLD), and others known in the art.

As may be seen in FIGS. 4, 5A, and 5B, signal lines from the upper stack are connected to those of the lower stack. This can be accomplished in several ways. In a first way, the signals are coupled using microwave cables 605, as shown in FIG. 6. The cables may be flexible or semi-rigid microwave cables. At the end of each cable is a cable screw connection 610, shown as a black square in the figure. At this site, a male cable is attached to a female housing, or vice versa. Preferably, each signal line is terminated at the edge of the switch card with a fixed cable termination that is acceptable for the frequency range of interest. For example, cables rated for zero to 40 GHz can be used for 40 GB/s analog signals. Each signal from a selected output of an 1×N switch card in the upper stack is directed into an N×1 switch card in the lower stack.

Referring to FIG. 7, another method of interconnection is shown. This method involves mechanical microwave feedthroughs that have three parts. The upper part is a screw-in connector into a cylindrical cavity 705 in the upper stack. When in position, this part has a cylindrical cavity facing downwards. The lower part is a screw-in connector into a cylindrical cavity 710 in the lower stack. When in position, this part has a cylindrical cavity facing upwards. The middle part is a cylindrical plug 715 which has a close tolerance to each of the cavities described above. This unit can be assembled as a press fit. Preferably, the cavities 705 and 710 are approximately 80 mils in diameter. Parts similar to those shown in FIG. 7 can be obtained commercially from Gilbert Company with an ability to pass microwave signals from 0 to 40 GHz with minimal loss.

The minimum pitch available today between two adjacent Gilbert connectors is 0.17 inches/card, which gives a packing density of 1/0.17=6 cards/inch. This is fairly low packing, and it is desirable to double this to 12 cards/inch. The pitch between lines is 0.17 inches, and there are 64 switch lines per card, resulting in a length of 64×0.17 inch =10.9 inches minimum and 12 inches in practice. However, the length of the transmission lines near the edge of a 12 inch board may cause an increase in the insertion loss of these lines to an objectionable value, on the order of 10 dB per decade in frequency. Also, for a non-blocking, non-reconfigurable N×N matrix shown in FIG. 4, there are N² interconnects, which is a costly item for large arrays, on the order of N>=64. Therefore, to reduce cost and loss of the switching array, a new interconnection concept is desirable.

Furthermore, connecting together two or more upper and lower switch cards may be labor intensive and require many electrical connectors. Also, disassembling and/or reworking such switches may be difficult.

Thus, what is needed is an efficient microwave switch design which allows efficient connection, disassembly, and reworking, without a large inventory of electrical connection supplies.

### SUMMARY OF THE INVENTION

An object of the present invention is to overcome the limitations in the art noted above, and to provide an efficient switch design capable of fast and inexpensive connection, disassembly, and reworking.

According to a first aspect of the present invention, method and apparatus for providing a microwave switch array includes structure and/or steps for providing a plurality of upper switch cards, each having at least one input and a plurality of outputs, and a plurality of lower switch cards, each having a plurality of inputs and at least one output. The plurality of lower switch cards being disposed perpendicular to said plurality of upper switch cards. Connector structure is disposed between the plurality of upper switch cards and the plurality of lower switch cards, the connector structure comprising a two-dimensional planar array of electrical-coupling terminals for electrically coupling the plurality of upper switch cards outputs to the plurality of lower switch card inputs.

According to another aspect of the present invention, method and apparatus for providing a microwave switch apparatus includes structure and/or steps for providing chassis having a first plurality of parallel slots disposed in a top portion thereof, and a second plurality of parallel slots disposed in a bottom portion thereof. The first plurality of slots being disposed orthogonal to said a second plurality of slots. A connector board is disposed in the chassis between the first and second plurality of slots. The connector board having an upper surface comprising a two-dimensional matrix of first signal terminals, and a lower surface comprising a two-dimensional matrix of second signal terminals. The first signal terminals being coupled to said second signal terminals.

According to a further aspect of the present invention, method and apparatus for providing a switch connector board for coupling a plurality of upper switch cards to a plurality of orthogonally-disposed lower switch cards includes structure and/or steps for providing a connector board upper surface having a two-dimensional array of signal-transmission terminals, each row of upper surface terminals being disposed to contact an edge of one of the plurality of upper switch cards. A connector board lower surface is provided having a two-dimensional array of signal-transmission terminals, each row of lower surface terminals being disposed to contact an edge of one of the plurality of lower switch cards. A plurality of connectors are disposed so as to extend through the connector board to electrically-couple the upper surface terminals to the lower surface terminals.

According to yet another aspect of the present invention, a method of assembling a microwave switch apparatus, comprises the steps of: (i) providing a plurality of upper switch cards, each having at least one input and a plurality of outputs; (ii) disposing a plurality of lower switch cards, each having a plurality of inputs and at least one output, perpendicular to said plurality of upper switch cards; (iii) disposing a connector board between the plurality of upper switch cards and the plurality of lower switch cards, said connector board comprising a two-dimensional planar array of electrical-coupling terminals; and (iv) pressing the plurality of upper switch card outputs and the plurality of lower switch cards inputs to said connector board to electrically couple the plurality of upper switch card outputs to the plurality of lower switch card inputs through the electrical-coupling terminals.

According to yet a further aspect of the present invention, a method of forming a matrix switch apparatus comprises the steps of: (i) providing a chassis having (1) a first plurality of parallel slots disposed in a top portion thereof for holding a corresponding plurality of upper switch cards, and (2) a second plurality of parallel slots disposed in a bottom portion thereof for holding a corresponding plurality of lower switch cards, said first plurality of slots being disposed orthogonal to said a second plurality of slots; and (ii) disposing a connector board in said chassis between the first and second pluralities of slots, said connector board having an upper surface comprising a two-dimensional matrix of first signal terminal, and a lower surface comprising a two-dimensional matrix of second signal terminals, said first signal terminals being coupled to said second signal terminals.

### BRIEF DESCRIPTION OF THE DRAWINGS

The present invention will be more easily understood from the following detailed description of the presently preferred embodiments, when taken in conjunction with the Drawings which show:

FIG. 1 is a block diagram of an optical-microwave-optical telecommunications system.

FIG. 2 is an illustration of the layout of the system of FIG. 1, including reshaping and retiming circuitry.

FIG. 3 is an illustration of the use of a 1×N switch to direct an input signal to an output that uses an N×1 switch.

FIG. 4 is an illustration of an arrangement of a double stack of switch cards, one stack functioning as a 1×N input switch array and the other stack functioning as an N×1 output switch array, according to an embodiment of the present invention.

FIGS. 5A and 5B are two cross-sectional views of the switch arrays of FIG. 4.

FIG. 6 is an illustration of a microwave interconnection between the two switch arrays of FIG. 4.

FIG. 7 is an illustration of a rigid mechanical interconnection between the two switch arrays of FIG. 4.

FIGS. 8A and 8B are schematic drawings showing a preferred system for coupling upper and lower switch cards, according to an embodiment of the present invention.

FIG. 9 is a schematic drawing showing the upper and lower switch cards of FIGS. 8A and 8B coupled together, according to an embodiment of the present invention.

FIGS. 10A and 10B are schematic drawings showing side and 3-D views of the upper and lower switch cards of FIGS. 8A and 8B.

FIGS. 11A and 11B are schematic drawings showing Joule heating structure according to an embodiment of the present invention.

FIG. 12 is a schematic drawing showing a variation of the Joule heating structure shown in FIGS. 11A and 11B.

FIG. 13 is a schematic drawing showing a packaged switch array from the top, according to an embodiment of the present invention.

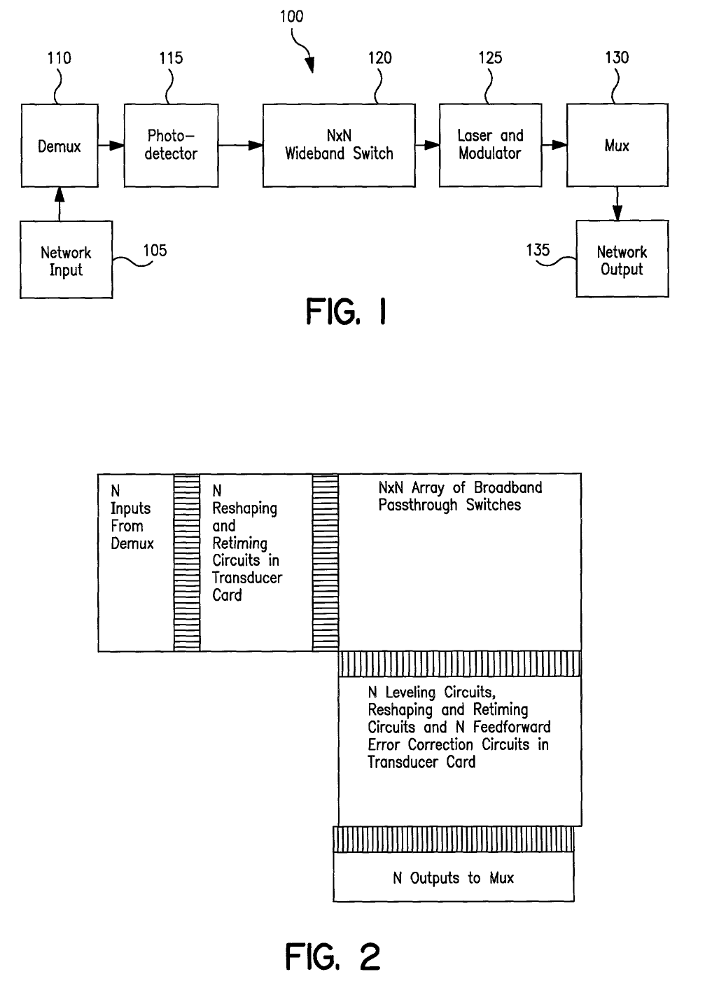

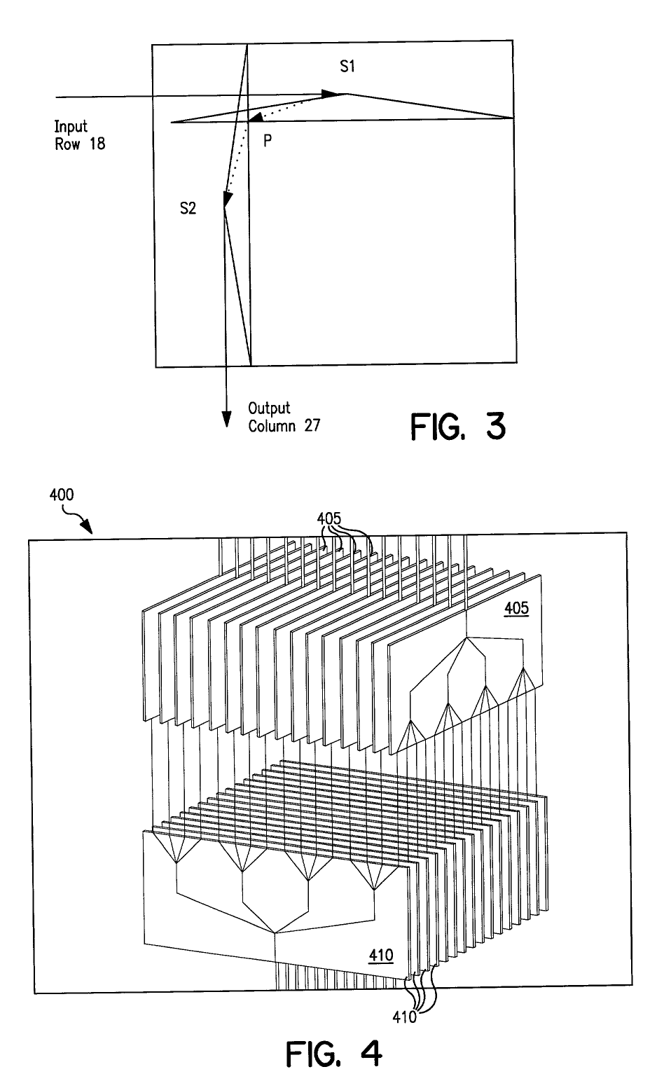

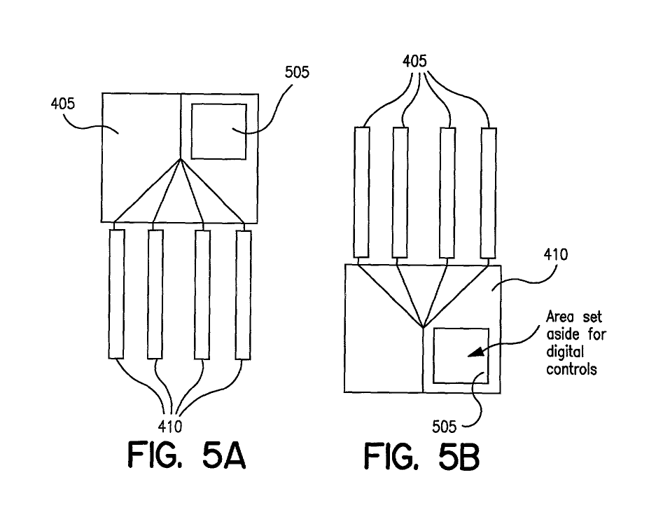

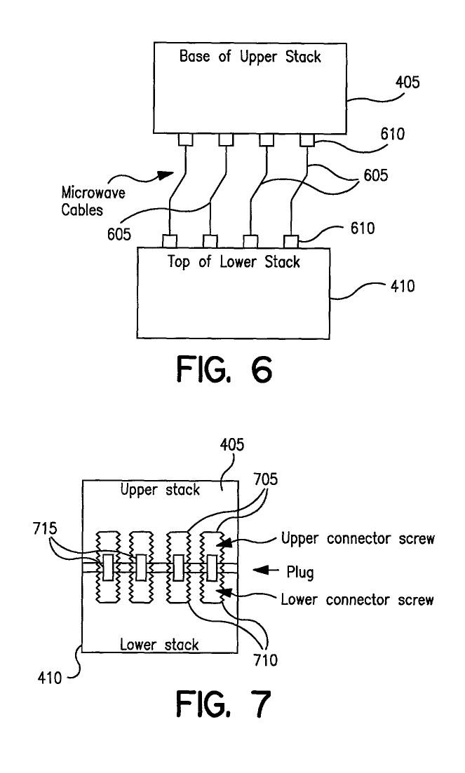

### DETAILED DESCRIPTION OF THE PRESENTLY PREFERRED EMBODIMENTS

1. Introduction

In general, the present invention provides structure and methods for enabling fast, efficient coupling between upper and lower switch cards, for example, those depicted in FIG. 4. However, the person of ordinary skill in the switching art will recognize that the advantages of the present invention may be applied to other areas of coupling design as well. Briefly, the preferred embodiment disposes “wells” at the mating edges of each of the upper and lower switch card, the wells being adapted to contact complementary conductor posts carried by a connector board that is placed between the upper and lower switch cards. The posts preferably have solder balls which protrude from the upper and lower surfaces of the connector board. This way, placement of the connector board between the arrays of upper and lower switch cards will enable immediate electrical coupling between all of the signal paths of the upper and lower switch cards. The connector board may also have heater wiring to enable reflow of solder from outside the assembled switch.

2. Structure

The preferred embodiment uses a rectangular (e.g. square) array of planar coaxial feedthrough integrated connectors to form a coplanar-to-coplanar coupling between the upper switch cards and the lower switch cards.

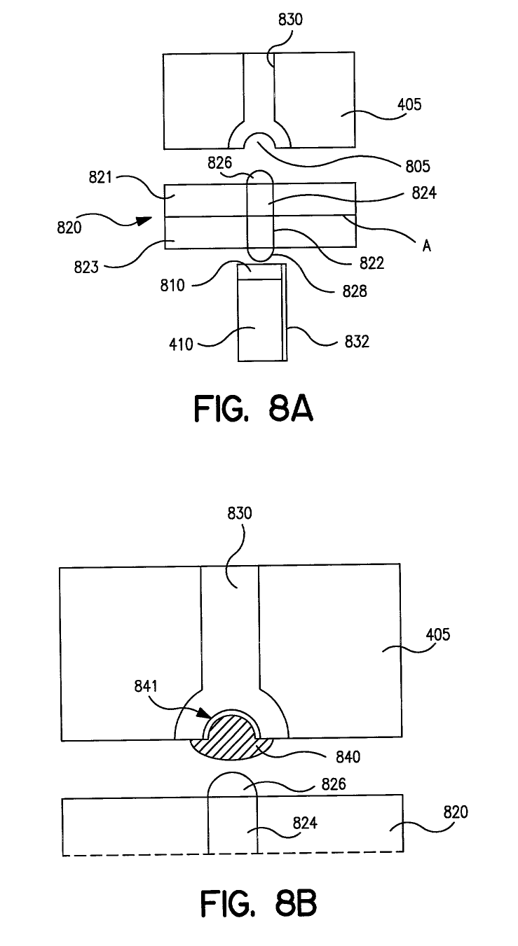

FIG. 8A shows an upper card 405 which is to be coupled to a lower card 410 via a connector board 820. The upper card 405 is schematically shown in plan view, while the lower card 410 and the connector board 820 are schematically shown in side view. Each upper card 405 and lower card 410 is terminated in a respective convex surface or well 805, 810 that is designed to mate with a complementary central conductor post 822 of the connector board 820. Connector board 820 comprises an upper board 821 adjacent the upper card 405, and a lower board 823 adjacent the lower card 410. Each conductor post 822 preferably comprises a cylindrical via 824 capped on two ends with respective hemispherical solder bumps 826, 828. Each card will have a linear array of such wells, and the connector board 820 will have a two-dimensional matrix of conductor pins 822 (where plural upper cards are coupled to plural lower cards). Of course, many alternative coupling structures are possible, such as pins and slots, planar contacts, spring-biased terminals, prongs, etc. Also, the wells may be formed on the connector board, with corresponding protrusions on the switch cards. Alternatively, the connector board may have wells on one side and corresponding protrusions on the opposite side. In this case, either the upper cards or the lower cards would have wells, and the other cards would have the protrusions. All such alternative coupling structures are contemplated by the present invention.

The lower face of the upper card 405 thus resembles a sequence of wrap-around serrated vias, like the edge of a postage stamp, precisely mated to fit to the solder balls 826 on the top of the conductor posts 822. The lower card 410 is also shaped in the same way, to mate with the solder balls 828 on the bottom of the conductor posts 822.

Metallization patterns 830 and 832, respectively on the upper and lower cards 405, 410, are coplanar and preferably comprise a sequence of ground-signal-ground electrodes (See, for example, FIG. 10A). Preferably, the coplanar line is not abruptly terminated at the edge, but has a metallization pattern in the shape of a curved fork, in order to maintain a smooth transition between the well and the solder bump, to achieve a 50 ohm transmission line through the connector.

The connector board 820 preferably is a 6 inch×6 inch board comprising 99.6% alumina with filled vias. In FIG. 8A, what does the horizontal line A is a symmetry axis in the longitudinal direction.

As shown in FIG. 8B, a small quantity of conductive adhesive 840 (of solder paste, epoxy, or the like) is disposed in the well, in between the card and the solder bumps. One means of adding the conductive adhesive is by screen printing, although any alternative means for depositing the adhesive in the wells may be adopted. The adhesive 840 may be pre-positioned in the wells, for convenience during shipment and assembly. Alternatively, the adhesive may be placed on the solder bumps. The adhesive may be applied immediately before making the connection, or at any time beforehand, as the particular application may require. In FIG. 8B, 841 represents an incomplete epoxy/solder coverage in a wrap around via (half-cylindrical vias at the edge of the substrate).

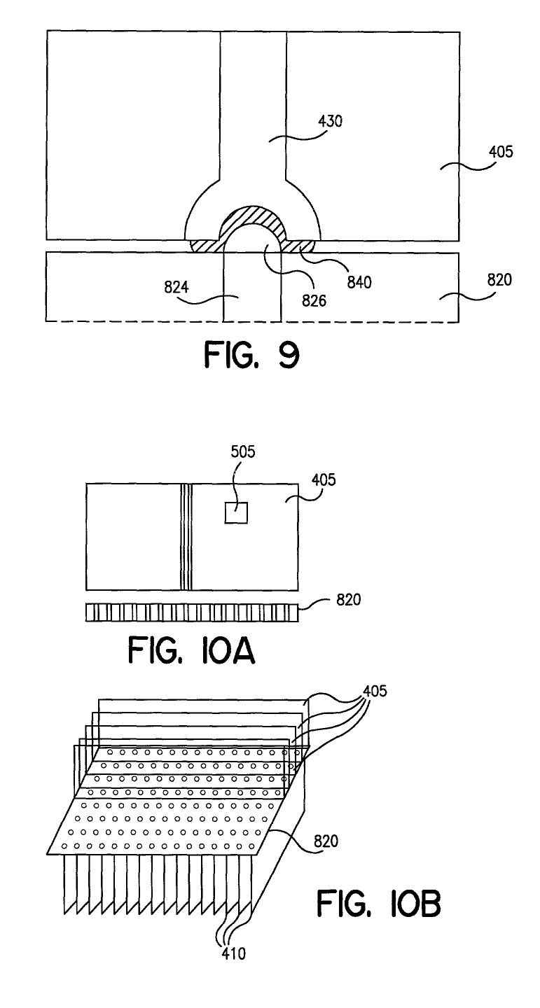

FIG. 9 depicts the adhesive 840 somewhat flattened after the upper card 405 is pressed downward on to connector board 820. The lower card 410 will look the same, except it will be rotated by 90 degrees. Upon the application of pressure, the conductive adhesive deforms and fills in the gaps between the card and the solder bump, thereby creating a strong bond with good electrical contact.

FIGS. 10A and 10B depict a cube switch array concept according to a preferred embodiment. A plurality of upper cards 405 are coupled to a plurality of lower cards 410 via a connector board 820. Each upper card 405 has a plurality of wrap around vias, or wells 805 for contact with the solder balls 826 of the connector board 820. The upper card 405 may comprise a sequence of ground-signal-ground electrodes (coplanar lines with ground on both sides of the signal path circuitry, useful in quasi-TEM mode transmission), as shown. The lower cards 410 may have the same configuration.

Some millimeter packaging techniques (see, for example, “Ball Grid Arrays: A DC to 31.5 GHz Low Cost Packing Solution for Microwave and mmwave MMICs.” Microwave Journal, Jan 1998, by Panicker, Douriet, Hyslop and Greenman, Micro Substrates Corp. (MSC) Tempe, Ariz.; incorporated herein by reference) may be adapted for use in the preferred embodiment. In particular, isolated vias filled with copper tungsten may be disposed in a ceramic package with a grid array of solder bumps on both faces of the package, in order to couple the horizontal lines of wells on the upper card to horizontal lines of wells on the bottom card. Those of skill in the board fabrication art will recognize that there are a wide variety of processes which may be applied to manufacture such a connector board.

A benefit of this above-described design is that the pitch between vias can be<≈0.08 inch which is about half of the Gilbert connector pitch of 0.17 inch. The overall width of a 1×64 board can thus be reduced from about 12 inches to about 6 inches. This size reduction greatly reduces the insertion loss on the board due to the skin effect at high frequencies. The reduced card size allows more choices of substrate material selection. For example, alumina (ceramic) has very low loss but does not allow large card area, as in Rogers (PTFE) materials (Rogers Corp. Microwave Material Division, 100 S. Roosevelt Avenue, Chandler, Ariz. 85226). Therefore a small panel size made of alumina has the lowest loss for the switch matrix, and this is made possible by the invention above.

3. In Situ Solder Reflow

In a switch array having a plurality of upper and lower switch cards, it is prudent that faulty ones be removed without affecting the others. For this purpose, a post-assembly rework strategy is needed. One method of allowing easy rework involves reflow of solder. To get the solder to reflow, heat must be applied locally to the solder and the defective parts can be removed.

Another method of allowing easy rework involves removal of the conductive epoxy. To remove the epoxy, heat must also be applied locally, but the required temperature is less than that of solder.

In both of these options, it is necessary to add heat locally. This may be difficult to accomplish in a switch array with high packing density of switch cards, since the area of interest lies in the center of the array at the solder bumps in between the upper and lower switch cards.

In order to melt solder or soften epoxy it is necessary to heat the materials. It is very difficult to design a thermal wand to reach into the very narrow gap of 0.050 inch between adjacent plates. Furthermore, global heating such as furnace heating is deleterious, since it may degrade device performance. In order to solve these thermal problems, it is preferred to use local Joule heating. A procedure for using local Joule heating is described below.

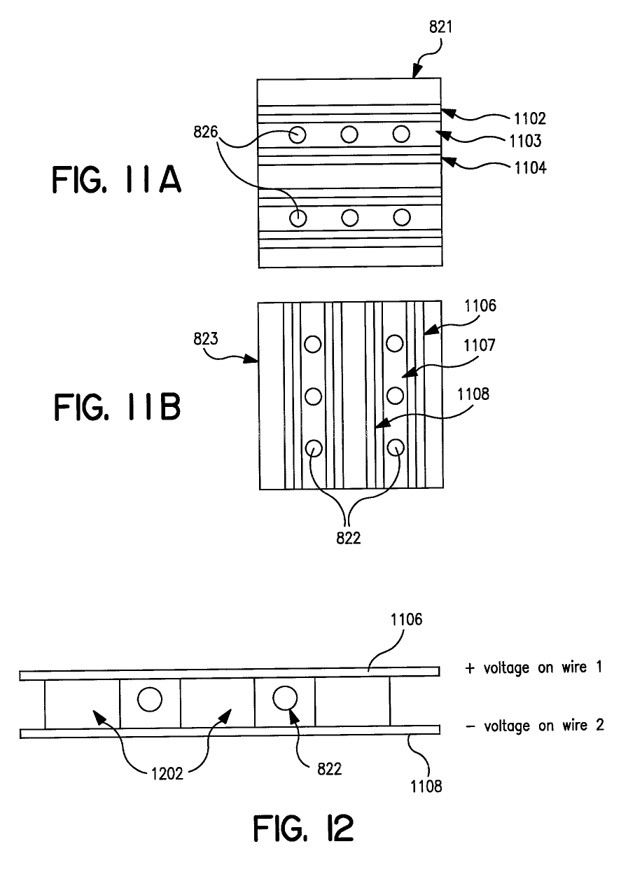

A preferred method of applying local heat is by Joule heating using specially designed wires mounted on the upper board 821 and the lower board 823 of the connector board 820, as shown in FIGS. 11A and 11B. Joule heating wires 1102, 1104, 1106, 1108 may be incorporated into the connector board design by using circuit integration techniques (for example, photolithography), or they can be free-standing wires bonded to the surface. The wires may, for example, be a 5.5 micro-ohm-cm tungsten line with a width of 0.005 inches (0.0125 cm), a thickness of 150 microinches (0.00038 cm), and a length of 6 inches (15 cm). These wires preferably run parallel to the direction of the solder bumps 822, 826, and are located on opposite sides of the positions reserved for the switch card, such positions indicated at 1103 and 1107. These positions may be inked or otherwise marked on the board 820 for ease of assembly, as shown. When current is passed through wires of finite resistance, the wires become locally heated. By this means, it is possible to locally heat the solder bumps, either for initial adhesion of a switch card to the connector board, or for removal of a switch card, without disturbing other solder bumps or switch cards. The Joule heating can be accomplished with AC using a Variac attached to a 120 volt wall outlet.

In more detail, if tungsten is used for the metal wires (as can be obtained by evaporation using photolithography), then a calculation can be made of its resistance. With resistivity 5.5 micro-ohm-cm, line width of 0.005 inches (0.0125 cm), thickness 150 microinches (0.00038 cm) and length of 6 inches (15 cm) the resistance of the wire is 16 ohms. The application of 20 volts gives a power of 25 watts, and a current of 1.25 amps. This power is distributed over an area of nominally 0.0125 cm×15 cm=0.18 cm, which gives a peak power density of 138 wafts/cm². This should be sufficient to locally melt solder in a short time. It is best to activate the two tungsten wires on each side of the card position in order to double the heat power and increase the local power density. Contact with the thin, evaporated tungsten wires can be made by placing probe tips on laterally expanded wire pads at the periphery. In case the of freestanding tungsten wires, which are thicker and more rugged than deposited wires, the attachment of the tungsten wires to the power supply can be accomplished without the need for probe tips. Of course, other wires can be used besides tungsten, and the wire dimensions and characteristics may be adopted for the specific switch being designed.

Another advantage of the Joule heating method described above is that this allows improved card alignment since visual assembly cues are provided by the parallel metal wires.

A variation on the Joule heating method described above is shown in FIG. 12. Here, a very high resistance thin metal film 1202 is deposited between adjacent highly conductive metal wires 1106, 1108 of the type described in FIG. 11B. Care is taken to keep this thin metal film 1202 away from the solder bumps 822, since the bumps must be insulated from each other. This is accomplished by segmenting the film as shown in the FIG. 12. A positive voltage is applied to one of the wires and a negative voltage to the other, with the result that most of the Joule heating is produced in the thin metal film area between the wires, which is sufficiently close to the solder bumps 822 to melt them. A DC power supply is preferable with the variation in FIG. 12.

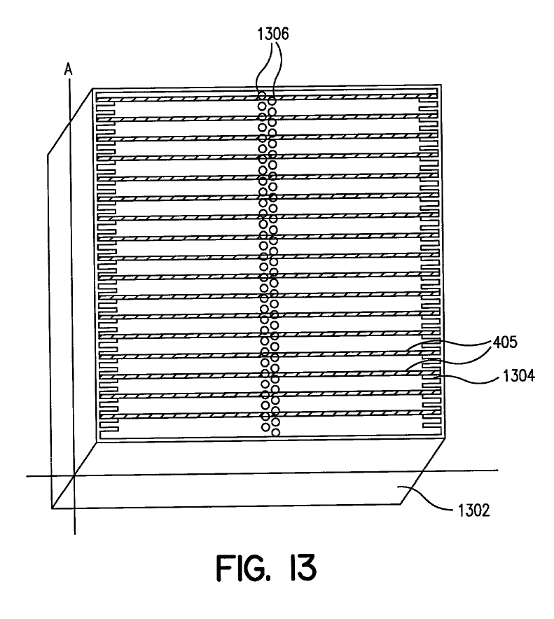

Using any of the structures described above, the packing of a 64×64 switch array can be very dense at 64 cards/6 inches≈11 cards/inch. A three dimensional view of such a switch array is shown in FIG. 13. This shows a system chassis 1302, looking from the top of the stack of upper switch cards 405. Slots 1304 are disposed to accept these upper switch cards. Of course, the bottom of the chassis 1302 has slots (not shown) disposed perpendicular to the upper slots 1304. A connector board 820 (not shown) is installed in the chassis 1302 at the chassis midline A. Terminals to couple power to the Joule heating wires of the connector board 820 may extend from the chassis side, or be accessible in openings in the chassis wall. If the chassis 1302 is assembled as a two-piece structure, the connector board 820 may be installed between upper and lower chassis halves. The holes 1306 are provided in the panel for the input/output cables.

4. Assembly

Assembling the matrix switch array of FIG. 13 is relatively straightforward. First, the chassis 1302 is assembled, with the connector board 820 disposed between upper and lower chassis halves. The Joule heating wire terminals are made accessible from the outside of the assembled chassis. Second, one or more upper switch cards 405 are installed in their corresponding slots 1304, and electrically coupled to the connector board 820 (either by pressing the card down to make good electrical contact with a deformable conductive adhesive, or by activating the appropriate Joule heating wires to reflow the solder bumps 826). Third, one or more lower switch cards 410 are coupled to the chassis 1302 in the same manner as the upper switch cards. Lastly, the appropriate signal lines are coupled to the upper and lower switch cards. In this manner, a compact, efficient, low-loss, inexpensive, easily-maintained microwave switch array is provided.

5. Advantages

One advantage of this type of switch assembly is to minimize cost by avoiding the use of expensive individual mechanical RF connectors in each assembly. Other advantages include: the pitch between the RF feedthroughs being reduced by 2×; the size of the cube being reduced by 2×; and the RF losses being reduced by a factor =>2× (because of smaller RF paths on the smaller cards, enabled by the present invention). Also, the removal of Gilbert connectors improves insertion and reflection losses. Still another advantage is that the reduced cube size now allows the usage of alumina switch cards which have much less microwave absorption loss compared to other materials. Finally, the disclosed embodiment allows for ease of addition and replacement of switch cards using local Joule heating of solder bumps.

6. Conclusion

Thus, what has been described is a low-loss, inexpensive, compact, easy-to-assemble, easy-to-maintain microwave switch array with reduced losses and reflections, and methods of making and assembling such a switch array.

The individual components shown in outline or designated by blocks in the attached Drawings are all well-known in the microwave switching arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A microwave switch array, comprising:
a plurality of upper switch cards, each having at least one input and a plurality of outputs;
a plurality of lower switch cards, each having a plurality of inputs and at least one output, said plurality of lower switch cards being disposed perpendicular to said plurality of upper switch cards; and
connector structure disposed between the plurality of upper switch cards and the plurality of lower switch cards, said the connector structure comprising a two-dimensional planar array of electrical-coupling terminals for electrically coupling the plurality of upper switch cards outputs to the plurality of lower switch card inputs.

2. A switch array according to claim 1, wherein said connector structure comprises an alumina board, and wherein each electrical-coupling terminal comprises (i) a metallized via hole passing through said board, and (ii) a solder bump on each end of said via hole.

3. A switch array according to claim 2, wherein each output of each upper switch card and each input of each lower switch card comprises a well disposed in a lower edge of said each upper switch card and said each lower switch card, said well configured to electrically contact one of said solder bumps.

4. A switch array according to claim 3, wherein said each well has an interior surface which is metallized.

5. A switch array according to claim 4, further comprising a conductive adhesive disposed in each said well.

6. A switch array according to claim 1, further comprising a chassis configured to hold said plurality of upper switch cards, said plurality of lower switch cards, and said connector structure in an electrically-coupled configuration.

7. A switch array according to claim 1, wherein said connector structure comprises an upper surface and a lower surface, the planar array of electrical-coupling terminals extending from said upper surface to said lower surface, said upper surface having at least one joule heating conductor disposed in a first direction adjacent each row of electrical-coupling terminals on said upper surface, said lower surface having at least one joule heating conductor disposed in a second direction, perpendicular to said first direction, adjacent each row of electrical-coupling terminals on said lower surface.

8. A switch array according to claim 7, wherein said at least one joule heating conductor on both the upper and lower surfaces comprises first and second joule heating wires disposed on opposite sides of each row of electrical-coupling terminals.

9. A switch array according to claim 7, wherein each of said electrical-coupling terminals comprises an electrically conductive protrusion extending from the upper surface, and an electrically conductive protrusion extending from the lower surface.

10. A switch connector board for coupling a plurality of upper switch cards to a plurality of orthogonally-disposed lower switch cards, comprising:
a connector board upper surface having a two-dimensional array of signal-transmission terminals, each row of upper surface terminals being disposed to contact an edge of one of the plurality of upper switch cards;
a connector board lower surface having a two-dimensional array of signal-transmission terminals, each row of lower surface terminals being disposed to contact an edge of one of the plurality of lower switch cards; and
a plurality of connectors extending through the connector board and electrically-coupling the upper surface terminals to the lower surface terminals.

11. A switch connector board according to claim 10, wherein each of said plurality of connectors comprises a metallized via hole extending through the connector board, and wherein each of said upper surface terminals comprises a solder bump protruding above the upper surface of the connector board.

12. A switch connector board according to claim 10, further comprising a first plurality of heating conductors disposed in a first direction on the connector board upper surface, and a second plurality of heating conductors disposed in a second direction, perpendicular to the first direction, on the connector board lower surface, each heating conductor disposed adjacent a row of surface terminals and configured to provide heat thereto.

13. A switch connector board according to claim 12, further comprising a plurality of high resistance elements respectively disposed between the surface terminals in each row, and configured to provide heat to adjacent surface terminals.

14. Matrix switch apparatus, comprising:
a chassis having a first plurality of parallel slots disposed in a top portion thereof, and a second plurality of parallel slots disposed in a bottom portion thereof, said first plurality of slots being disposed orthogonal to said a second plurality of slots; and
a connector board disposed in said chassis between the first and second plurality of slots, said connector board having an upper surface comprising a two-dimensional matrix of first signal terminals, and a lower surface comprising a two-dimensional matrix of second signal terminals, said first signal terminals being coupled to said second signal terminals.

15. Apparatus according to claim 14, wherein each of said first and second signal terminals comprises a solder bump, and further comprising a conductor extending through said connector board between each pair of first and second signal terminals.

16. Apparatus according to claim 15, further comprising:
a first plurality of pairs of heating conductors disposed on the connector board upper surface, each pair straddling a row of the first signal terminals and configured to transmit heat to the solder bumps of said first row; and
a second plurality of pairs of heating conductors disposed on the connector board lower surface, each pair straddling a row of the second signal terminals and configured to transmit heat to the solder bumps of said second row, said second plurality of pairs of heating conductors being disposed perpendicular to said first plurality of pairs of heating conductors.

17. Apparatus according to claim 14, further comprising a plurality of upper switch cards disposed in said first plurality of parallel slots, and a plurality of lower switch cards disposed in said second plurality of parallel slots.

18. Microwave switch apparatus, comprising:
a plurality of upper switch card means, each having at least one input and a plurality of outputs, for selectively switching signals from the plurality of upper switch card means inputs to the plurality of upper switch card means outputs;
a plurality of lower switch card means, each having a plurality of inputs and at least one output, for selectively switching signals from the plurality of lower switch card means inputs to the plurality of upper switch card means outputs, said plurality of lower switch card means being disposed perpendicular to said plurality of upper switch card means; and
connector means, disposed between the plurality of upper switch cards and the plurality of lower switch cards, for connecting the plurality of upper switch card means outputs to the plurality of lower switch card means inputs, said connector means comprising a two-dimensional planar array of electrical-coupling means for electrically coupling the plurality of upper switch card means outputs to the plurality of lower switch card means inputs.

19. Switch apparatus according to claim 18, wherein said connector means comprises an alumina board, and wherein each electrical-coupling means comprises (i) a metallized connector means passing through said board, and (ii) a solder bump on each end of said connector means.

20. Switch apparatus according to claim 19, wherein each output of each upper switch card means and each input of each lower switch card means comprises a well disposed in a lower edge of said each upper switch card means and said each lower switch card means, said well configured to electrically contact one of said solder bumps.

21. Switch apparatus according to claim 20, wherein said each well has an interior surface which is signal-transmissive.

22. Switch apparatus according to claim 21, further comprising conductive adhesive means disposed in each said well.

23. Switch apparatus according to claim 18, further comprising chassis means for holding said plurality of upper switch card means, said plurality of lower switch card means, and said connector means in an electrically-coupled configuration.

24. Switch apparatus according to claim 18, wherein said connector means comprises an upper surface and a lower surface, the planar array of electrical-coupling means extending from said upper surface to said lower surface, said upper surface having at least one joule heating conductor means disposed in a first direction adjacent each row of electrical-coupling terminals on said upper surface, said lower surface having at least one joule heating conductor means disposed in a second direction, perpendicular to said first direction, adjacent each row of electrical-coupling means on said lower surface.

25. Switch apparatus according to claim 24, wherein said at least one joule heating conductor means on both the upper and lower surfaces comprises first and second joule heating wires disposed on opposite sides of each row of electrically-conducting means.

26. Switch apparatus according to claim 24, wherein each of said electrical-coupling terminals comprises an electrically conductive protrusion extending from the upper surface, and an electrically conductive protrusion extending from the lower surface.

27. Switch connector apparatus for coupling a plurality of upper switch cards to a plurality of orthogonally-disposed lower switch cards, comprising:
a connector board means upper surface having a two-dimensional array of signal-transmission terminal means, each row of upper surface terminal means being disposed to contact an edge of one of the plurality of upper switch cards;
a connector board means lower surface having a two-dimensional array of signal-transmission terminal means, each row of lower surface terminal means being disposed to contact an edge of one of the plurality of lower switch cards; and
a plurality of connector means extending through the connector board means and electrically-coupling the upper surface terminal means to the lower surface terminal means.

28. Switch connector apparatus according to claim 27, wherein each of said plurality of connector means comprises a metallized conductor means extending through the connector board means, and wherein each of said upper surface terminal means comprises a solder bump protruding above the upper surface of the connector board.

29. Switch connector apparatus according to claim 28, further comprising a first plurality of heating conductor means disposed in a first direction on the connector board upper surface, and a second plurality of heating conductor means disposed in a second direction, perpendicular to the first direction, on the connector board lower surface, each heating conductor means disposed adjacent a row of surface terminal means, for providing heat thereto.

30. Switch connector apparatus according to claim 29, further comprising a plurality of high resistance means, respectively disposed between the surface terminal means in each row, for providing heat to adjacent surface terminal means.

31. Matrix switch apparatus, comprising:
chassis means having (i) a first plurality of parallel slots disposed in a top portion thereof for holding a corresponding plurality of upper switch cards, and (ii) a second plurality of parallel slots disposed in a bottom portion thereof for holding a corresponding plurality of lower switch cards, said first plurality of slots being disposed orthogonal to said a second plurality of slots; and
connector board means disposed in said chassis means, for coupling the first and second pluralities of slots, said connector board means having an upper surface comprising a two-dimensional matrix of first signal terminal means, and a lower surface comprising a two-dimensional matrix of second signal terminal means, said first signal terminal means being coupled to said second signal terminal means.

32. Apparatus according to claim 31, wherein each of said first and second signal terminal means comprises a solder bump, and further comprising conductor means extending through said connector board means between each pair of first and second signal terminal means.

33. Apparatus according to claim 32, further comprising:
a first plurality of pairs of heating conductor means disposed on the connector board means upper surface, each pair straddling a row of the first signal terminal means, for transmitting heat to the solder bumps of said first row; and
a second plurality of pairs of heating conductor means disposed on the connector board means lower surface, each pair straddling a row of the second signal terminal means, for transmitting heat to the solder bumps of said second row, said second plurality of pairs of heating conductor means being disposed perpendicular to said first plurality of pairs of heating conductor means.

34. Apparatus according to claim 31, further comprising a plurality of upper switch cards disposed in said first plurality of parallel slots, and a plurality of lower switch cards disposed in said second plurality of parallel slots.

35. A method of assembling a microwave switch apparatus, comprising the steps of:
providing a plurality of upper switch cards, each having at least one input and a plurality of outputs;
disposing a plurality of lower switch cards, each having a plurality of inputs and at least one output, perpendicular to said plurality of upper switch cards;
disposing a connector board between the plurality of upper switch cards and the plurality of lower switch cards, said connector board comprising a two-dimensional planar array of electrical-coupling terminals; and
pressing the plurality of upper switch card outputs and the plurality of lower switch cards inputs to said connector board to electrically couple the plurality of upper switch card outputs to the plurality of lower switch card inputs through the electrical-coupling terminals.

36. A method according to claim 35, wherein the step of disposing a connector board comprises the step of disposing a connector board that comprises an alumina board, and wherein each electrical-coupling terminals comprises (i) a metallized connector passing through said alumina board, and (ii) a solder bump on each end of said connector board.

37. A method according to claim 36, further comprising the step of forming a well in a lower edge of said each upper switch card and said each lower switch card, said well configured to electrically contact one of said solder bumps.

38. A method according to claim 37, wherein said each well has an interior surface which is signal-transmissive.

39. A method according to claim 38, further comprising the step of disposing a conductive adhesive in each said well.

40. A method according to claim 35, further comprising the step of disposing said plurality of upper switch cards, said plurality of lower switch cards, and said connector board in a chassis in an electrically-coupled configuration.

41. A method according to claim 35, wherein said connector board comprises an upper surface and a lower surface, the planar array of electrical-coupling means extending from said upper surface to said lower surface, and further comprising the steps of disposing at least one joule heating conductor in a first direction adjacent each row of electrical-coupling terminals on said upper surface, and disposing at least one joule heating conductor in a second direction, perpendicular to said first direction, adjacent each row of electrical-conducting terminals on said lower surface.

42. A method according to claim 41, wherein each step of disposing at least one joule heating conductor includes the step of disposing first and second joule heating wires on opposite sides of each row of electrical-conducting terminals.

43. A method according to claim 41, wherein the step of disposing the connector board comprises the step of disposing a connector board wherein each of said electrical-coupling terminals comprises an electrically conductive protrusion extending from the upper surface, and an electrically conductive protrusion extending from the lower surface.

44. A process for coupling a plurality of upper switch cards to a plurality of orthogonally-disposed lower switch cards, comprising the steps of:
providing a connector board upper surface having a two-dimensional array of signal-transmission terminals, each row of upper surface terminals being disposed to contact an edge of one of the plurality of upper switch cards;
providing a connector board lower surface having a two-dimensional array of signal-transmission terminals, each row of lower surface terminals being disposed to contact an edge of one of the plurality of lower switch cards; and
disposing a plurality of connectors extending through the connector board and electrically-coupling the upper surface terminals to the lower surface terminals.

45. A process according to claim 44, wherein the step of disposing the plurality of connectors comprises the step of disposing connectors such that each connectors comprises a metallized conductor extending through the connector board, and such that each of said upper surface terminals comprises a solder bump protruding above the upper surface of the connector board.

46. A process according to claim 45, further comprising the step of disposing a first plurality of heating conductors in a first direction on the connector board upper surface, and a second plurality of heating conductors in a second direction, perpendicular to the first direction, on the connector board lower surface, each heating conductor being disposed adjacent a row of surface terminals, for providing heat thereto.

47. A process according to claim 46, further comprising t he step of disposing a plurality of high resistance means, respectively between the surface terminals in each row, for providing heat to adjacent surface terminals.

48. A method of forming a matrix switch apparatus, comprising the steps of:
providing a chassis having (i) a first plurality of parallel slots disposed in a top portion thereof for holding a corresponding plurality of upper switch cards, and (ii) a second plurality of parallel slots disposed in a bottom portion thereof for holding a corresponding plurality of lower switch cards, said first plurality of slots being disposed orthogonal to said a second plurality of slots; and
disposing a connector board in said chassis between the first and second pluralities of slots, said connector board having an upper surface comprising a two-dimensional matrix of first signal terminal, and a lower surface comprising a two-dimensional matrix of second signal terminals, said first signal terminals being coupled to said second signal terminals.

49. A method according to claim 48, wherein each of said first and second signal terminals comprises a solder bump, and further comprising the step of disposing a plurality of conductors extending through said connector board between each pair of first and second signal terminals.

50. A method according to claim 49, further comprising the steps of:
disposing a first plurality of pairs of heating conductors on the connector board upper surface, each pair straddling a row of the first signal terminals, for transmitting heat to the solder bumps of said first row; and
disposing a second plurality of pairs of heating conductors on the connector board lower surface, each pair straddling a row of the second signal terminals, for transmitting heat to the solder bumps of said second row, said second plurality of pairs of heating conductors being disposed perpendicular to said first plurality of pairs of heating conductors.

51. A method according to claim 48, further comprising the step of disposing a plurality of upper switch cards in said first plurality of parallel slots, and a plurality of lower switch cards in said second plurality of parallel slots.
